(19) United States
(12) Patent Application Publication
(10) Pub. No.: US 2009/0123606 A1
(43) Pub. Date: May 14, 2009

(54) Carbohydrate modifying agent and drinks containing the modifying agent

(76) Inventors: Frank Corsini, East Dennis, MA (US); Richard Kozlenko, San Rafael, CA (US)

Correspondence Address: JAY P. HENDRICKSON, 1010 B STREET, SUITE 319, SAN RAFAEL, CA, 94901, US

(21) Appl. No.: 12/319,644

(22) Filed: Jan. 9, 2009

Related U.S. Application Data
(63) Continuation-in-part of application No. 10/155,865, filed on May 24, 2002.
(60) Provisional application No. 60/293,657, filed on May 25, 2001.

(51) Int. Cl. A23L 1/302

(52) U.S. Cl. 426/61

(57) ABSTRACT

A carbohydrate modifying formulation that modulates the rate of sugar absorption and/or metabolism in a subject to whom the formulation is administered. In one embodiment, the formulation comprises an active soluble fiber, one or more polyphenolic compounds, an aqueous diluent, and sugar. In another embodiment, the formulation is a dry powder that comprises an active soluble fiber, antioxidant containing botanical extracts, crystalline fructose, a probiotic, vitamins and minerals.

### CROSS-REFERENCES TO RELATED APPLICATIONS

The present application is a continuation-in-part of U.S. patent application Ser. No. 10/155,865, filed on May 24, 2002, which in turn claims priority under 35 U.S.C. 119(e) from U.S. Provisional Patent Application No. 60/293,657, filed on May 25, 2001.

### BRIEF SUMMARY OF THE INVENTION

The present invention provides a carbohydrate modifying formulation or agent of synergistic ingredients, pertaining to the metabolism of mono and disaccharides. Metabolically, the formulation of the invention slows the absorption of sugars, modifies the release of insulin, and stabilizes blood sugar response. Additionally, the oral ingestion of the formulation of the invention prevents or reduces the formation of dental caries by inhibiting the metabolic capability of dental plaque-forming bacteria to convert sugars into erosive, tooth-decaying acids.

The formulations of the invention provide direct and indirect positive effects on sugar metabolism and blood sugar response. Thus, the formulations of the invention, when consumed in normal amounts, do not adversely contribute or aggravate such conditions as obesity, diabetes, or dietary-based, hormone related hyperactivity such as that often described in young children.

A formulation of the invention may be in liquid or dry form. That is, it may be in the form of a powder that comprises or contains the formulation, or in the form of a liquid, either an aqueous liquid or a non-aqueous liquid. In one preferred aspect, the invention provides a finished, water-based beverage, into which the formulation of the invention is incorporated. Moreover, the invention provides a finished water-based beverage, which is acidified and which includes a formulation of the invention.

The invention also includes a method of slowing absorption of sugars, for instance, from the intestine of a subject (including but not limited to a human individual), that comprises administering to the subject, or making available for ingestion by the mammal, a formulation of the invention. The formulation becomes effective when in an aqueous medium, which may be provided extrinsically, for instance by oral or intravenous administration or ingestion of an aqueous liquid containing the formulation, or intrinsically, for instance by ingestion of a solid formulation of the invention which is acted on by the body's digestive secretions and conveyed to and through the body's digestive system (an aqueous environment).

Additional objects and advantages of the invention will be apparent from the detailed description as follows:

### DETAILED DESCRIPTION OF THE INVENTION AND THE PREFERRED EMBODIMENTS

The present invention provides a formulation having desirable properties built upon synergistic ingredients; maintaining low simple sugar levels; and slowing down the normally rapid absorption of simple sugars from the gut. This objective best optimizes energy levels by thwarting the potential destabilizing effects on blood sugar and insulin response, by preferably utilizing a polysaccharide matrix of complex carbohydrates and soluble gum fibers.

The invention provides numerous advantages not found in other agents including, but not limited to, limiting the effects of excessive use of ingredients, such as sugar, that may promote greater oxidative stress and actually reduce energy. Ingredients are preferably chosen from among those that neutralize and inhibit free radical production and oxidative stress and, therefore, help to protect the cellular energy generating mechanisms. Moreover, presently preferred ingredients are those that assist in the cellular utilization and burning of fuels for energy. The composition of the invention also provides multiple tiered uses of various timed caloric energy fuels plus the sweetness system disclosed herein for longer, sustained energy.

The present invention provides compositions of active and, optionally, inactive ingredients. The compositions can be prepared in any form including, but not limited to, dry formulations, aqueous formulations, and the like. The compositions of the invention can be included in substantially any manufactured foodstuff or beverage. When consumed simultaneously or in time proximity with other foods that contain sugars, the carbohydrate modifying effects of the compositions will extend to and similarly influence those sugars that are undergoing digestion and assimilation.

A presently preferred embodiment of the composition includes one or more polyphenolic compounds. While not being bound to any particular theory of operation, the inventors presently prefer polyphenolic compounds that inhibit the digestive enzymes amylase (starch digestion) and sucrase (sugar digestion), thereby slowing sugar absorption, and reducing overstimulation of the insulin response, and the subsequent modification of sugar metabolism.

Moreover, preferred polyphenolic compounds inhibit the activity of the bacterial enzyme, glucan transferase, which metabolizes simple sugars as found in beverages, into sticky dental plaque. Without the sticky plaque present, the bacteria cannot adhere to the tooth surfaces, ferment the sugars into acids, and create dental caries.

Polyphenolic compounds of use in the present invention are isolated from any convenient source. Preferred polyphenolic compounds include catechins, tannin extracts, extracts of Camellia Sinesis (e.g. green and black teas), and those found in cranberry, aronia berry, bilberry, and grape seed. Other useful sources of polyphenolic compounds will be apparent to those of skill in the art.

Preferred green tea and black teas actives are the catechins and the aflavins.

The polyphenols can be present in the formulation in any useful amount, but they are preferably present in an amount of from about 0.2 mg to about 500 mg (in 8 oz of water or other water or other diluent, when a diluent is used), preferably from about 10 to about 500 mg.

The formulations of the invention also preferably include on or more amino acid or source of amino acid, preferably selected from soy, soy sprouts or other legume derived proteins such as mung bean, or dairy based protein, amino chelated minerals, and whey or other dairy-based proteins. Other useful sources of amino acid are known to those of skill in the art.

The amino acids of use in the present invention are preferably free amino acids, most preferably free glycine and arginine, which lower blood sugar levels by virtue of mild inducement of insulin release from the pancreas. Arginine, independent of insulin release, also stimulates release of GH (growth hormone) from the pituitary gland. GH is a natural counterbalance to the excessive hypoglycemic effects of insulin. Moreover, glycine, independent of energy dynamics, is an amino acid neurotransmitter substrate, that is described in the scientific literature as being inhibitory to neurological hyperactivity.

Thus, a presently preferred source of amino acid is soy protein, which is a rich source of glycine and arginine, improves glucose tolerance and peripheral insulin sensitivity which is crucial for blood sugar stability.

The one or more amino acid can be present in the composition in any useful amount, but is preferably present in an amount of from about 5 mg to about 10 grams (per 8 ounces of water or other diluent, when a diluent is used) preferably from about 200 mg to about 10 grams. When the amino acid is provided by a source of amino acid, other than the free amino acid, the source is preferably present in an amount that provides the preferred amount of the free amino acid.

Also present in preferred formulations of the invention is soluble fiber, preferably active soluble fiber. As used herein, “active soluble fiber” refers to soluble fiber that is biologically responsive to bacteria in the mammalian GI tract and/or participates in one or more blood sugar modifying mechanism in vivo. The soluble fiber is from any source, however, preferred fibers are those that participate in one or more blood sugar modifying mechanism, such as: (1) conversion of the soluble fiber into short chain fatty acids (SCFAs) by the intestinal bacteria (SCFA, particularly propionic acids, increase glycolysis and reduces gluconeogenesis thus normalizing blood sugar); and (2) slowly of the absorption of sugar from the intestinal tract by solution fiber; which ultimately influences the rate of sugar metabolism.

Additionally, antioxidants, including phenolic-based botanical extracts are optionally included as a component of the present formulation. The presence of the antioxidant can aid in overcoming or blunting the pro-oxidant and destabilizing hypoglycemic effects of quickly absorbed simple sugars found in most commercial beverages.

Presently preferred soluble fibers having the above-described characteristics include, insulin, FOS (fructo-oligosaccharides e.g. Belaflora™), and gums.

The soluble fiber is present in any useful amount, but is preferably present in any amount of from about 100 mg to about 8 grams (per 8 ounces of water or other diluent, when a diluent is used), preferably from about 500 mg to about 8 grams. In those embodiments in which 5 grams or more soluble fiber is present, the composition of the invention is preferably able to reduce the post prandial rise in blood sugar levels.

In another preferred embodiment of the invention, the formulation includes one or more zinc salt or other source of the zinc ion. Metabolically, zinc is a critical nutrient in the synthesis of insulin and the metabolism of carbohydrates. From a dental perspective, cardiogenic bacteria enzymatically produce an insoluble glucan deposit from simple sugars present in the mouth that firmly adheres to the enamel tooth surface. Original study at UCSF School of Preventative Dentistry by the present inventors, demonstrated that two tested zinc salts, 0.5% zinc solution (zinc chloride) and same concentration of zinc ascorbate, both inhibited the growth and adherence of mutans streptococci in vitro. This demonstrates that the zinc cation, not the counter ion, is the most significant portion of the salt molecule for this function.

Preferred sources of the zinc ion include zinc chloride, zinc sulfate, zinc ascorbate, zinc picolinate, zinc amino acid chelates, and zinc-EDTA.

The zinc salt(s) is present in any useful quantity, but is preferably present in an amount of from about 1 mg to about 40 mg (per 8 ounces of water or other diluent, when a diluent is used).

In another preferred embodiment, the invention provides an acidic finished drink composition. The drink is preferably water-based. The water used to formulate the drink can be, for example, still, carbonated, or dairy-based. The pH of the finished drink is preferably from about 1 to about 7, more preferably from about 1 to about 5, and more preferably from about 1 to about 3. The solubility and assimilation of mineral salts, especially divalent minerals such as calcium, zinc, magnesium, iron, are enhanced in an acidic medium. These elements have many important roles relating to cellular metabolism and tissue structure.

The acid or source of acid includes both organic and inorganic acids. Exemplary organic acids include phosphoric acid.

The source of the sugars relevant to the operation of the composition of the invention can be contained in the inventive formulation itself, or they may be derived from other foodstuffs.

Also provided by the present invention is a method for modulating sugar metabolism in a mammalian subject. The method includes administering to the subject a composition of the invention, thereby modulating sugar metabolism of the subject. The method also includes making a composition of the invention available to the subject for ingestion, for instance by providing it through retail outlets or through a dispensing physician or other health care provider. The compositions may be provided per se, or may be contained in food supplements or food products. In a preferred embodiment, the moderating results in a decrease of the rate of sugar metabolism relative to the rate in the absence of a composition of the invention. In another preferred embodiment, the moderating includes a linearization of the rate of metabolism, eliminating spikes and/or valleys in the sugar metabolism profile, and/or decreasing the peak height and/or valley depth in the sugar metabolism profile. In another preferred embodiment, the sugar metabolism is modulating by the composition effecting a decrease in the absorption rate of the sugar by the mammalian gut.

In another embodiment of the present invention, the carbohydrate modifying formulation is in the form of a dry, anhydrous, powder that may be included or added to any beverage or foodstuff that the consumer desires to sweeten. More specifically, the powder formulation contains a soluble fiber, and most preferably, contains an active soluble fiber. As used herein, “active soluble fiber” refers to soluble fiber that is biologically responsive to bacteria in the mammalian GI tract and/or participates in one or more blood sugar modifying mechanisms in vivo. The active soluble fiber can be from any source, however, preferred fibers are those that participate in one or more blood sugar modifying mechanism, such as: 1) conversion of the soluble fiber into short chain fatty acids (SCFAs) by the intestinal bacteria (SCFA, particularly propionic acids, increase glycolysis and reduces gluconeogenesis thus normalizing blood sugar); and (2) slowing of the absorption of sugar from the intestinal tract by the soluble fiber, which ultimately influences the rate of sugar metabolism. The most preferred active soluble fiber is an anhydrous oligosaccharide, such as oligofructose.

The powder formulation also contains a plurality of antioxidant containing botanical extracts, and most preferably contains the following botanical extracts: cinnamon, Golgi berry, bittermelon, and grape seed. These botanical extracts perform three primary functions in the body: 1) produce antioxidants that can be used to inhibit and remove free radicals; 2) assist in inhibiting glycation so that cells are more readily able to metabolize sugar; and 3) facilitate insulin performance. In this regard, the botanical extracts exhibit a synergistic relationship with the active soluble fiber oligofructose. When the oligofructose enters the intestinal tract, intestinal flora rapidly metabolizes the oligofructose into short chain fatty acids. This metabolism occurs more rapidly than it does with other fibers. As a result, the short chain fatty acids are ultimately delivered to the blood stream and to cellular structures faster than the delivery of the short chain fatty acids that are produced from the conversion of other fiber sources. This rapid deployment of the short chain fatty acids to cellular structures is very beneficial because the fatty acids, along with the body's immune system, act to remove free radicals that are produced during cellular metabolism.

In addition, some of the botanical extracts have a synergistic relationship inter se. It is believed that of the four botanical extracts cinnamon is the most active compound in facilitating insulin performance. As a result, it would be beneficial to enhance the activity of cinnamon. In this regard, the inventors further believe that the compound procyanidin in grapeseed extract and the compound anthocyanin in Golgi berry extract act together to enhance the action of cinnamon in the body, giving rise to an unexpected increase in the activity of cinnamon in facilitating insulin performance.

The powder formulation also contains a sugar and it is most preferable that the sugar is crystalline fructose. Fructose is included in the formulation due to the fact that it does not provoke an insulin response as readily as other sugars. Additionally, fructose is very efficient as a sweetener in that on a per calorie basis it is at least 1/12 times sweeter than sucrose. As a result, a desired level of sweetening can be obtained by using smaller amounts of fructose than would be needed if sucrose were used. In this regard, it has been suggested that fructose helps in the absorption of antioxidants through the intestinal tract.

The powder formulation further contains a spore-forming probiotic compound that is included in order to assist in maintaining a healthy digestive tract and a strong immune system. Most preferably the spore-forming probiotic is Bacillus coagulans that does not need to be refrigerated and is most effective in surviving the harsh stomach acids before entering the intestinal tract. When the probiotic reaches the intestinal tract its spores are then able to germinate and colonize in the intestines, thereby creating a healthier bacterial flora. Simultaneously, the Bacillus coagulans acts as a catalyst in causing the oligofructose and botanical extracts to form a more robust fermentation complex, which enhances the ability of the oligofructose to produce the short chain fatty acids and to slow the absorption of sugar. This fermentation complex also acts to enhance the ability of the botanical extracts to perform their functions in the body as described above.

In addition, the powder formulation contains a plurality of vitamins and minerals and most preferably contains vitamins B12, B6, B3 (niacinamide), biotin, and folic acid, and minerals chromium and selenium. The B vitamins are included in the formulation because they are active in the metabolism of carbohydrates and act synergistically with oligofructose that acts to modulate the rate of sugar absorption into the blood stream from the GI tract. Selenium is a mineral antioxidant that helps to prevent free radical formation during cellular metabolism. Chromium assists insulin at the cellular level making it more efficient in removing glucose from the blood and providing the glucose to cells for metabolism.

The powder formulation can be readily packaged in dose size containers or bags for use by a person who desires to use the formulation as a sweetening agent to be added to a beverage or food stuff. Upon ingestion, the formulation acts to modulate sugar metabolism, which results in a decrease of the rate of sugar metabolism in the person's body relative to the person's metabolism rate that is not being modulated by the formulation. The modulation of sugar by the formulation can also include a linearization of the rate of metabolism, eliminating spikes and/or valleys in the person's sugar metabolism profile, and/or decreasing the peak and/or valley depth in the sugar metabolism profile. The formulation can also be used to modulate sugar metabolism by decreasing the absorption rate of the sugar in the person's gut.

The following examples are provided to solely illustrate some specific applications of the powder formulation and are not intended to describe any additional limitations. Persons skilled in the art will readily recognize a variety of non-critical parameters that could be changed or modified to yield essentially similar results.

### EXAMPLES

### Example 1

### Yogurt Drink (8 oz)

Combine yogurt cultured milk, fresh fruit and sugar (10 g) or intense sweetener of choice (10 ppm) with the modifying agent. The modifying agent includes insulin fibers (3 g), bilberry, citrus bioflavonoid, green tea extract mix (polyphenolic) (100 mg); soy isoflavones (50 mg); zinc sulfate (7 mg); and vitamin C (60 mg). Add sufficient water to bring volume to 8 ounces.

### Example 2

### Soft Drink (8 oz)

Combine water (still or carbonated) flavor (natural or artificial) and sugar (10 gm) or an intense sweetener of choice (10 ppm) with the modifying agent.

The modifying agents includes insulin fiber (3 g), bilberry, citrus bioflavonoids, green tea extract mix (polyphenolic) (100 mg); soy isoflavones (50 mg); zinc sulfate (7 mg); and vitamin C (60 mg); soy protein extract (50 mg): and mineral amino chelates (amino acid glycine) (300 mg).

### Example 3

### Powder (2 Gram) for Beverages

Create the powder formulation by combining by mixing oligofructose, crystalline fructose, botanical extracts, vitamins and minerals, Bacillus coagulans, and natural flavors and masking agents; with the oligofructose included in an amount of approximately 60% by weight of the formulation, the crystalline fructose included an amount of approximately 33.23% by weight of the formulation, the botanical extracts included in an amount of approximately 0.62% by weight of the formulation, and the vitamins and minerals included in the in an amount of approximately 0.775% by weight of the formulation, the Bacillus coagulans included in an amount of approximately 0.35% by weight of the formulation, and the natural flavors and masking agents included in an amount of approximately 5% by weight of the formulation. The botanical extracts include one part each of cinnamon extract, bittermelon extract, Golgi berry extract, and gragpeseed extract. The vitamins and minerals are included in the following weights: B12 (0.3 mcg), folic acid (20 mcg), B6 (60 mcg), niacinamide (B3) (0.6 mg), biotin (15 mcg), chromium (3.6 mcg), and selenium (2.1 mcg).

Two grams of the above powder formulation can then be added to 1 cup of any hot or cold beverage that a consumer desires to sweeten. For example the beverage can be coffee, tea, unsweetened hot cocoa in hot milk in order to make hot chocolate, unsweetened lemon juice in order to make lemonade, unsweetened carbonated flavor waters, unsweetened protein powder energy drinks made with milk, water, juice yogurt, or soy milk.

### Example 4

### Powder for Foodstuffs

Two or more grams (or more to taste) of the powder formulation can be added to any foodstuff that a consumer desires to sweeten. For example, the formulation can be added to hot or cold cereals, French toast, baking goods and fresh fruit.

### Example 5

### Powder as a Sugar Additive

One part of the powder formulation can be added to and mixed with three parts of traditional granulated sugar (sucrose) in a sugar bowl. In this manner, the normal sugar is partially transformed to a sweeter that has the benefits of the powder formulation of the present invention.

Although the carbohydrate modifying formulation of the present invention has been described in several embodiments, it will be recognized by those skilled in the art that other embodiments and features may be provided without departing from the underlying principals of those embodiments. The scope of the invention is defined by the appended claims.

All publications and patent documents cited in this application are incorporated by reference in their entirety for all purposes to the same extent as if each individual publication or patent document were so individually denoted. By their citation of various references in this document, Applicants do not admit any particular reference is “prior art” to their invention.

1. A powder formulation, comprising:
an active soluble fiber;
a plurality of antioxidant containing botanical extracts;
crystalline fructose;
a probiotic;
a plurality of vitamins; and
a plurality of minerals.

2. The powder formulation as in claim 1 in which the active soluble fiber is oligofructose.

3. The powder formulation as in claim 1 in which the plurality of antioxidant containing botanical extracts is cinnamon, Golgi berry, bittermelon, and grapeseed.

4. The powder formulation as in claim 1 in which the probiotic is Bacillus coagulans.

5. The powder formulation as in claim 1 in which the plurality of minerals is chromium and selenium.

6. The powder formulation as in claim 1 in which the plurality of vitamins is B12, B6, B3 (niacinamide), biotin, and folic acid.

7. An aqueous formulation, comprising:
a polyphenolic compound;
an active soluble fiber;
a water-based aqueous diluent, and
sugar,
wherein the ratio of the amount of sugar to said active soluble fiber is approximately 3 parts of sugar to 1 part of active soluble fiber.
